(19) United States
(12) Patent Application Publication
(10) Pub. No.: US 2020/0045152 A1
(43) Pub. Date: Feb. 6, 2020

(54) ADJUSTABLE PHONE LENS ACCESSORY AND METHOD OF USE

(71) Applicant: Santana L. Nottage, Owings Mill, MD (US)

(72) Inventor: Santana L. Nottage, Owings Mill, MD (US)

(21) Appl. No.: 16/394,827

(22) Filed: Apr. 25, 2019

Related U.S. Application Data
(60) Provisional application No. 62/764,370, filed on Aug. 1, 2018.

(51) Int. Cl. H04M 1/02; G02B 13/00; G02B 3/02; G02C 7/02; G02B 25/00; G02B 27/02

(52) U.S. Cl. CPC H04M 1/027; G02B 13/0015; G02B 3/02; G02B 27/026; G02B 25/005; G02B 27/027; G02B 27/025; G02C 7/02

(57) ABSTRACT

An accessory for use with a phone or tablet computer. The accessory connects to the phone, either by enveloping the phone with a case-like element or clipping to the side of the phone with a clip. A hinged lens covers at least a portion of the screen and pivotally connects to the connection portion. This lens can be tilted up from the screen to increase the effective prescription of the lens, enlarging the text and images on the screen of the phone, or can be tilted back down towards the screen to reduce the effect.

### CROSS-REFERENCE TO RELATED APPLICATION

This application claims priority in U.S. Provisional Patent Application No. 62/764,370 Filed Aug. 1, 2018, which is incorporated herein by reference.

### BACKGROUND OF THE INVENTION

### 1. Field of the Invention

The present invention relates generally to a phone accessory and method for use thereof, and more specifically to an adjustable phone lens accessory.

### 2. Description of the Related Art

Correcting vision is a common and ongoing problem. Existing products for correcting vision during normal day to day activities include glasses and contacts. Products such as the customizable eyeglass system and method of use described in U.S. Pat. No. 9,817,247 and its continuation-in-part application Publication No. 2018/0039098, both of which are incorporated herein by reference, teach methods and systems for easily adjustable eyewear for everyday use. However, people tend to remove their glasses and contacts at night when they are sleeping. This causes issues when they receive a phone call or message or need to check their phone quickly for any other reason. The user would have to find their glasses or put in their contacts to be able to read their phone screen. What is needed is a device to allow for quick viewing of a phone screen for people who need vision correction.

Heretofore there has not been available a system or method for an adjustable phone lens accessory with the advantages and features of the present invention.

### BRIEF SUMMARY OF THE INVENTION

The present invention generally provides an accessory for use with a phone. The accessory connects to the phone, either by enveloping the phone with a case-like element or clipping to the side of the phone with a clip. A hinged lens covers at least a portion of the screen and pivotally connects to the connection portion. This lens can be tilted up from the screen to increase the effective prescription of the lens, enlarging the text and images on the screen of the phone, or can be tilted back down towards the screen to reduce the effect.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a first embodiment of the present invention having a case-like connection element shown in a closed orientation.

FIG. 2 is a three-dimensional isometric view thereof shown in an open orientation.

FIG. 3 is a three-dimensional isometric view thereof shown in an open orientation in combination with a typical phone element to be received by the connection element.

FIG. 4 is a top plan view thereof.

FIG. 5 is a front elevational view thereof.

FIG. 6 is a left side elevational view thereof.

FIG. 7 is a right side elevational view thereof.

FIG. 8 is a bottom plan view thereof.

FIG. 9 is a three-dimensional isometric view of a second embodiment of the present invention having a clip-like connection element shown in combination with a typical phone element.

FIG. 10 is a three-dimensional isometric view thereof showing the clip element clipped to the phone element in a first orientation.

FIG. 11 is a three-dimensional isometric view thereof showing the clip element clipped to the phone element in a second orientation.

FIG. 12 is a top plan view thereof.

FIG. 13 is a front elevational view thereof.

FIG. 14 is a left side elevational view thereof.

FIG. 15 is a right side elevational view thereof.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. First Embodiment Adjustable Phone Lens Accessory 2

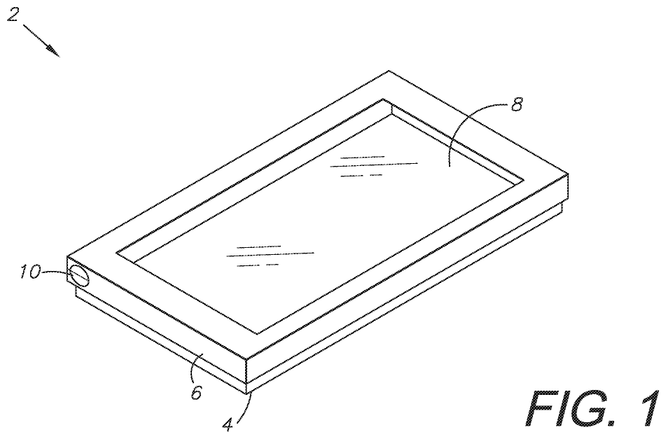

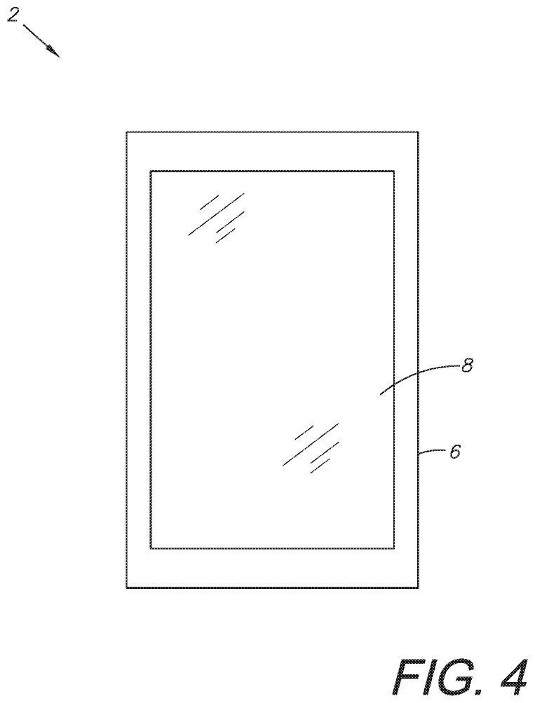

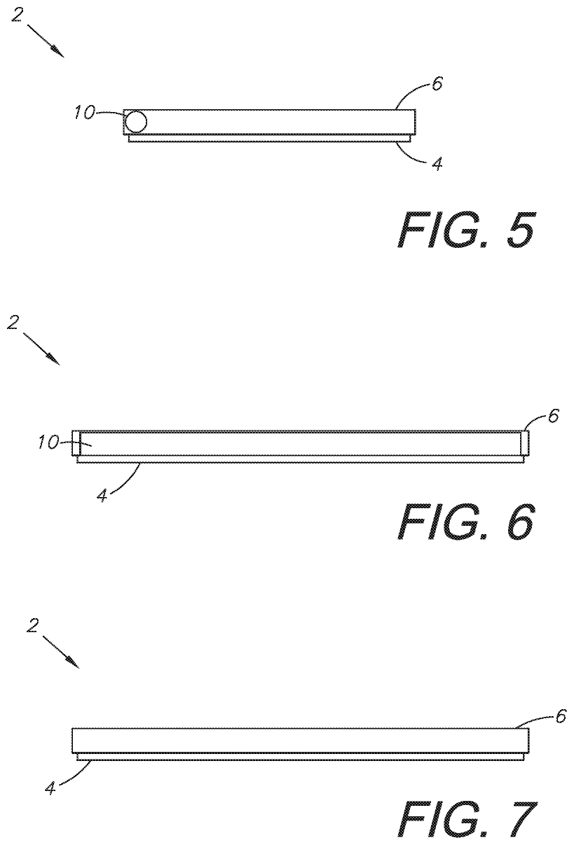

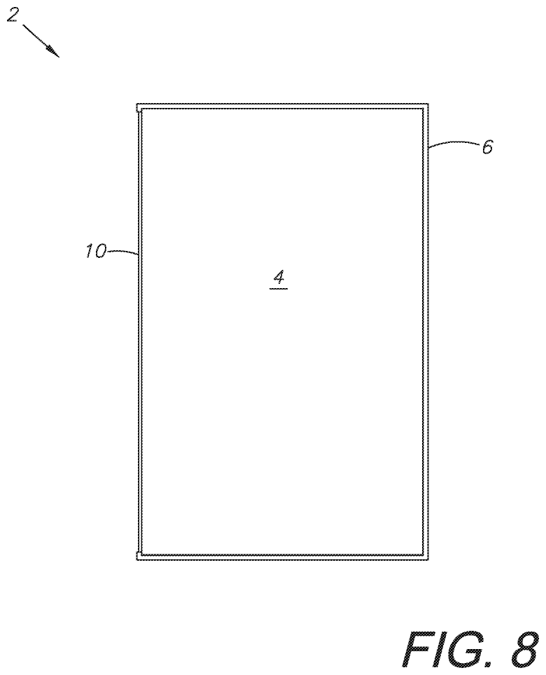

As shown in FIGS. 1-8, a first embodiment adjustable phone lens accessory 2 includes a phone case type connection element with a top portion 6 and a bottom portion 4 which connect by a hinged element 10 allowing the top portion to pivot up and away from the bottom portion. The top portion 6 also includes a plastic or glass lens 8 for magnifying a phone's 14 screen 16 stored within the accessory 2.

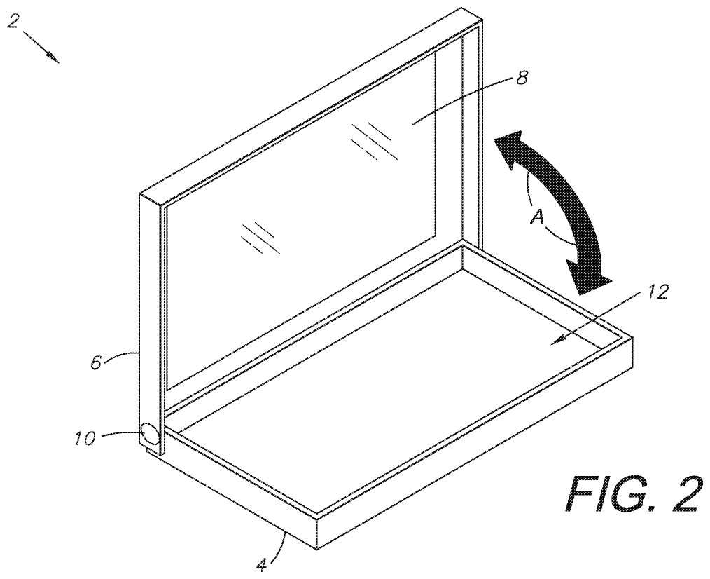

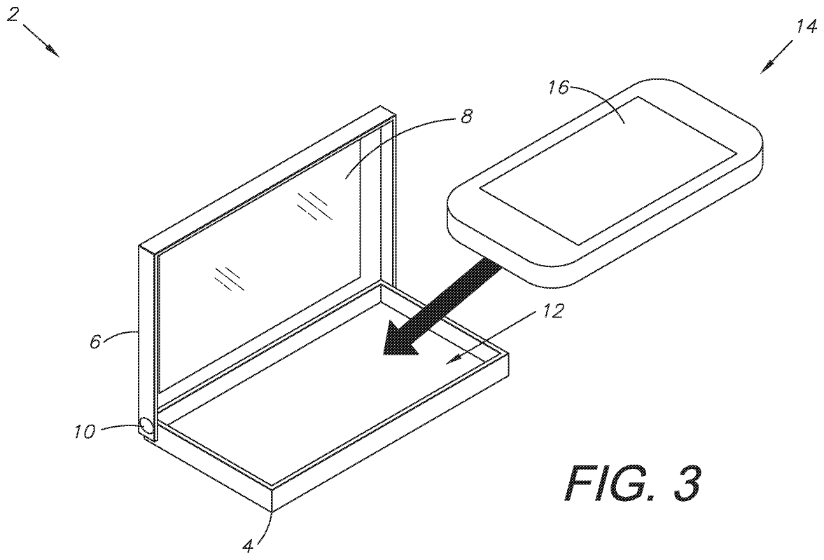

The accessory 2 can be opened as shown in FIG. 2 and a phone 14 can be inserted as shown in FIG. 3. After the phone is inserted into the space 12 within bottom portion 4, the top portion 6 can be moved to adjust the focus of the screen. Angle A shown in FIG. 2. adjusts the focus; the higher the tilt, the larger the images and text shown on the screen. This allows for quick viewing of the contents of the phone's 14 screen 16 when the user isn't wearing their vision correcting devices.

### III. Second Embodiment Adjustable Phone Lens Accessory 52

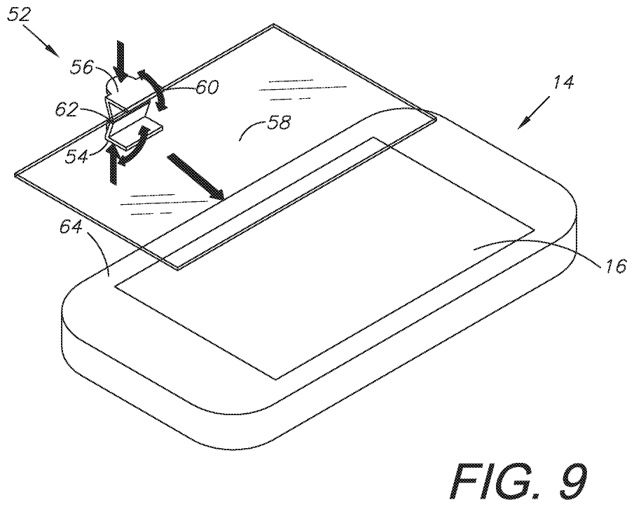

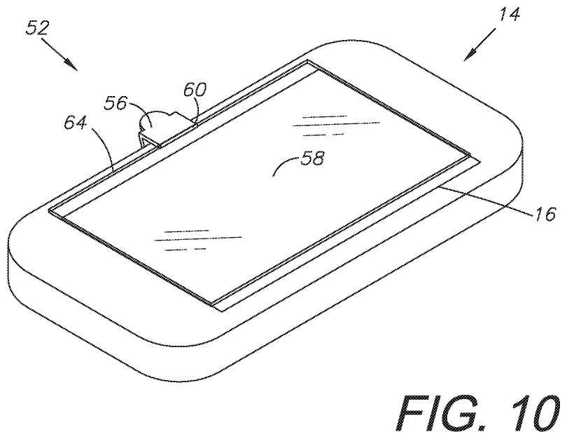

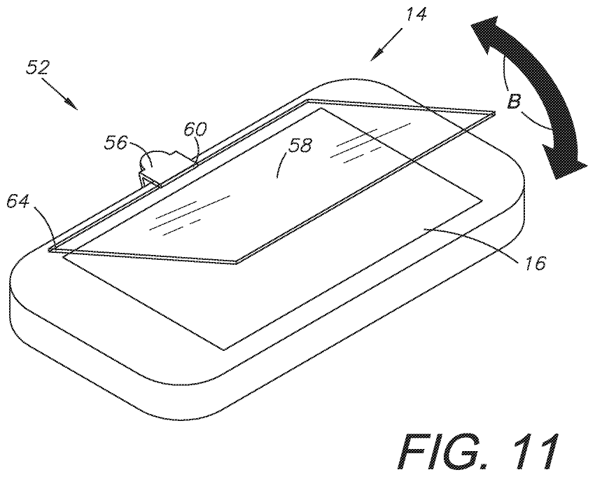

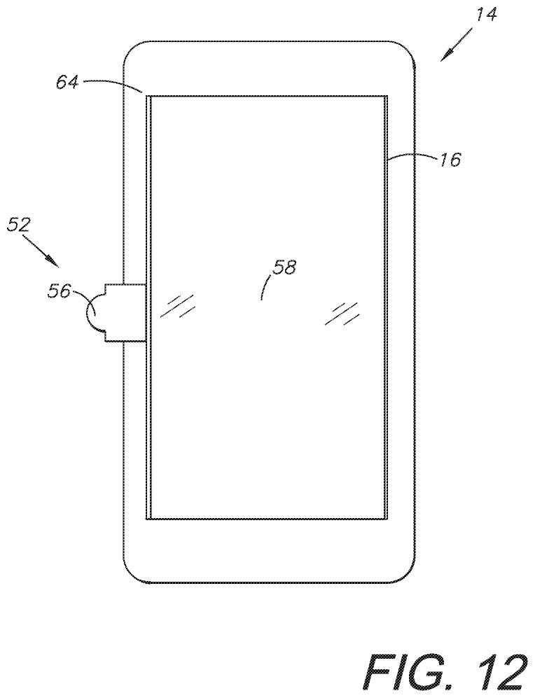

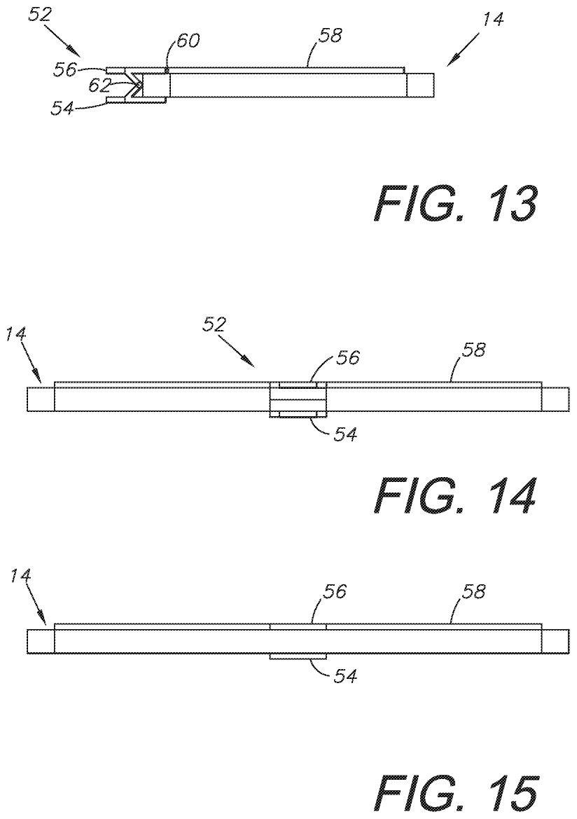

FIGS. 9-15 show a second phone lens accessory 52 embodiment which covers a portion of the screen 16 of a phone 14 with an adjustable lens 58. This embodiment generally features a clip element having a top portion 56 and bottom portion 54 joined by a spring hinge 62 or other suitable element allowing the top and bottom portions 56, 54 to be pressed to open the clip and then automatically retract, allowing the clip to clamp about the edge 64 of the phone 14. The lens 58 is attached to the top portion 56 of the clip with a hinge element 60. This allows the clip accessory 52 to function similarly to the previous embodiment, where the further the lens 58 is lifted up along angle B of FIG. 11, the greater the effect of enlargement of text or other information on the phone's 14 screen 16.

For either embodiment, the lens 8, 58 should preferably be a convex lens where the lens power is spherical in strength. The power of the prescription being applied by the lens should be consistent throughout the entirety of the lens. Such power ranges that would be used here range from +1.00 through +5.00. The lens 8, 58 of either embodiment is able to magnify the image of the phone's 14 screen 16 at any angle, whether perpendicular, vertical, or any angle in between.

A tablet computer could also be used with an embodiment of the present invention and would function similarly to how the phone described above when interacting with either phone lens accessory 2, 52.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. An accessory for use with a phone having a display screen, the accessory comprising:
a connector configured for engaging at least a portion of a body of a phone;
said connector having a top portion and a bottom portion;
a lens affixed to said top portion, said lens configured to be selectively moveable to an angle between a first orientation parallel to a screen of said phone and a second orientation perpendicular to said screen; and
wherein said angle of said lens provides visual enhancement of information presented on said screen of said phone.

2. The accessory of claim 1, further comprising:
said connector comprising a phone case;
said bottom portion configured to receive said phone within an internal space; and
said top portion hingedly affixed to said bottom portion and configured to enclose said phone within said internal space.

3. The accessory of claim 2, further comprising said lens comprising a prescription lens.

4. The accessory of claim 1, further comprising:
said connector comprising a clip;
said top portion and bottom portion of said connector joined at a hinge; and
wherein said clip is configured for clasping an edge of said phone.

5. The accessory of claim 4, further comprising said lens comprising a prescription lens.

6. The accessory of claim 1, further comprising said lens being a convex lens.

7. The accessory of claim 6, further comprising said lens being spherical in strength.

8. The accessory of claim 7, further comprising said lens comprising a prescription lens throughout the entirety of the lens.

9. The accessory of claim 8, further comprising said lens having a power within a range of +1.00 to and including +5.00.

10. A method of enhancing viewing of a mobile phone device, the method comprising the steps:
providing a connector configured for engaging the mobile phone device, said mobile phone device comprising a casing and a screen, said casing comprising a front face border, side edges, and a back face, and said connector comprising a top portion, a bottom portion, and a lens having a hinged connection to said top portion;
engaging said connector with said mobile phone device such that said top portion is engaged with said front face border, said lens is in proximity with said screen, and said bottom portion is engaged with said back face; and
adjusting viewability of said screen by moving said screen about said hinged connection of said top portion, wherein said screen is configured to be moved between zero degrees perpendicular to said screen and ninety degrees parallel to said screen.

11. The method of claim 10, wherein:
said connector comprising a phone case;
said bottom portion configured to receive said phone within an internal space; and
said top portion hingedly affixed to said bottom portion and configured to enclose said phone within said internal space.

12. The method of claim 11, wherein said lens comprises a prescription lens.

13. The method of claim 10, wherein:
said connector comprising a clip;
said top portion and bottom portion of said connector joined at a hinge; and
wherein said clip is configured for clasping an edge of said phone.

14. The method of claim 10, wherein said lens comprises a prescription lens.

15. The method of claim 14, wherein said lens comprises a convex lens.

16. The method of claim 15, wherein said lens comprises spherical strength.

17. The method of claim 16, wherein said lens comprises a prescription lens throughout the entirety of the lens.

18. The method of claim 17, wherein said lens comprises a lens having a power within a range of +1.00 to and including +5.00.

19. An accessory for use with a tablet computer having a display screen, the accessory comprising:
a connector configured for engaging at least a portion of a body of a tablet computer;
said connector having a top portion and a bottom portion;
a lens affixed to said top portion, said lens configured to be selectively moveable to an angle between a first orientation parallel to a screen of said tablet computer and a second orientation perpendicular to said screen; and
wherein said angle of said lens provides visual enhancement of information presented on said screen of said phone.

20. The accessory of claim 19, further comprising:
said connector comprising a tablet computer case;
said bottom portion configured to receive said tablet computer within an internal space; and
said top portion hingedly affixed to said bottom portion and configured to enclose said tablet computer within said internal space.
